(19) United States
(12) Patent Application Publication
(10) Pub. No.: US 2021/0334861 A1
(43) Pub. Date: Oct. 28, 2021

(54) METHOD AND SYSTEM OF CREATING AND MARKETING A STORED VALUE DONATION

(71) Applicant: Christopher Eugene Elrod, Loudon, TN (US)

(72) Inventor: Christopher Eugene Elrod, Loudon, TN (US)

(21) Appl. No.: 16/858,605

(22) Filed: Apr. 25, 2020

(51) Int. Cl. G06Q 30/02; G06Q 20/36; G06Q 40/04; G06Q 30/06; G06Q 20/20; G06F 9/54

(52) U.S. Cl. CPC G06Q 30/0279; G06Q 20/367; G06Q 40/04; G06Q 30/0233; G06F 9/547; G06Q 20/209; G06Q 20/202; G06Q 30/0238; G06Q 30/0241; G06Q 30/0633

(57) ABSTRACT

The creation and marketing of a branded stored value currency by accepting a request can allow a variety of users to benefit from the donation being given by a user.

### BACKGROUND OF THE INVENTION

Over the last twenty years there has been a sharp decline in the amount of money that has been given to non-profit organizations. And in light of the recent COVID-19 pandemic, non-profit organizations simply lack the ability to withstand the mandatory shutdown. Even though there is a tremendous amount of giving taking place, many non-profits will simply fold due to the financial strain left upon the members that help carry out the vision.

What is desperately needed to help these “do-good” organizations continue in their quest is an ability for every donation to directly impact two specific types of givers: those that have cash, and those that have other types of resources.

The present invention is a method and system in which a donation can be created, marketed, and sold in a way that impacts multiple entities with every request made. In the case of the present invention every donation will specifically benefit the participating non-profit, local businesses that contribute, and the member-consumers that become engaged.

The present invention is in the field of charity.

The present invention is in the technical field of stored value payments.

### SUMMARY OF THE INVENTION

While accepting donations in the form of a substance other than cash is nothing new, the present invention will simply allow a non-profit organization to post a request to a local business owner (the giver) using a method and system capable of creating a stored value donation. The non-profit organization can then use this stored value donation to raise funds for their charity by allowing their members or attendees (a second giver) to exchange their donation for the donation made by the giver. After the exchange, the giver will simply accept the stored value donation they made to the non-profit organization as a method of payment from the second giver. The end result is that all parties get what they need when making donation of this type.

The present invention will have advancement over currently used systems and methods at least because it establishes the ability for businesses to give in a way that impacts their business, it requires no financial sacrifice to consumers that support participating charities, and for non-profits to retain the much needed resources garnered from the use of this type of method and system.

### BRIEF DESCRIPTION OF THE DRAWINGS

FIG. 1 is a flow chart of the method and process steps that demonstrate the present invention.

### DETAILED DESCRIPTION OF THE INVENTION

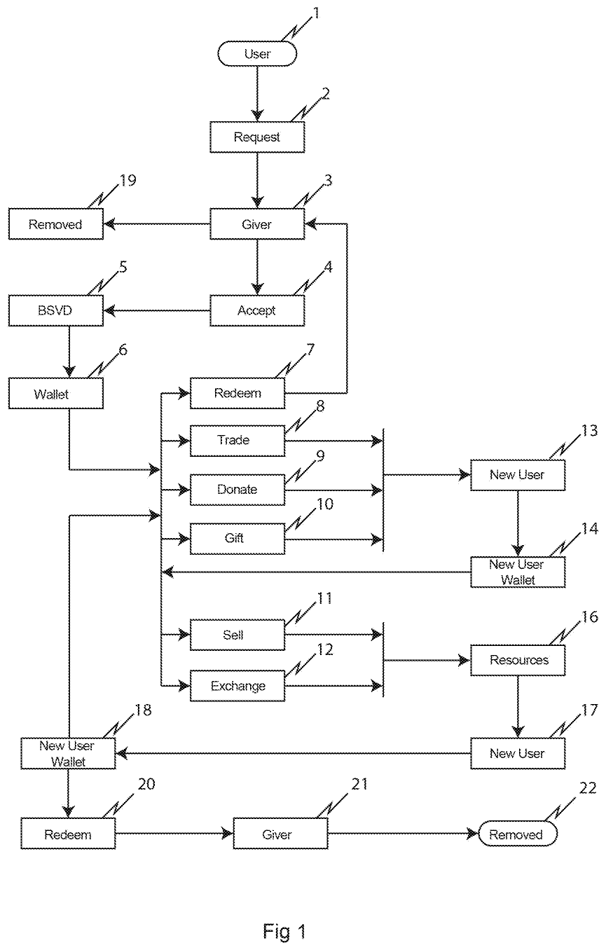

Referring now to the invention in more detail, in FIG. 1, there is shown a flow chart demonstrating a detailed description of the present invention in which a user 1 submits donation request 2 to a giver 3. Upon acceptance 4 the present invention will create a branded stored value donation 5 on behalf of the giver 4 and transfer it to the requesting user's wallet 6. Once the user 1 has received the branded stored value donation 5, in their wallet 6 the one making the request 1 is free to use the branded stored value donation 5 in a manner consistent with their wishes. They can redeem 7 it with the giver 3 in which case the stored value associated with the donation will be removed 19 from future use therefore ending the process. Furthermore, the user 1 can trade 8, donate 9, or gift 10, to a new user 13. In which case the branded stored value donation 5 is stored in the new user's wallet 14. The new user 13 can repeat the process of redeem 7, trade 8, donate 9 or gift 10 to a new user 13. Additionally, both the user 1 and the new user 13 can sell 11, or exchange 12 the branded stored value donation 5 for resources 16 such as a monetary donation, good, service, etc. When they do, the branded stored value donation 5 is then transferred to the new user (the buyer) 17 and stored in their wallet 18 and they, too are allowed to use the branded stored value donation 5 in a manner consistent with the present invention's capabilities. All of which will result in an outcome which ultimately requires the giver 21 must redeem 20 the branded stored value donation 5 created on their behalf. Upon redemption 20 by the giver 21 the process then completed with the removal 22 of the branded stored value 5 from use.

1. A system and method for creating a branded stored value from the acceptance a donation request presented to a giver the process comprising of:
a user;
generating a donation request;
transmitting or submitting that request to a giver;
a giver accepting the donation request;
the acceptance of the donation request creates a branded stored value donation on behalf of the giver;
a branded stored value donation deposited into the user's wallet;
a user determining whether to redeem, trade, donate, gift, sell, or exchange the branded stored value donation;
a venue in which to market or advertise the branded stored value donation;
an ability to accept resources as payment exchange for branded stored value donation;
the ability to submit transaction data from initiator to a database administered by an administrator;
selling said value to a purchaser;
original debtor redeeming their branded stored value;
completing said sale;
creating a branded stored value in lieu of commission owed if applicable;
a debt connected to a donation that can be offset or settled with the redemption of a branded stored value donation;
the process of selling, trading, donating, exchanging or gifting of a branded stored value donation created from the acceptance of a donation request can becoming self-perpetuating or self-eliminating.

2. A system and method for implementing and operating the present invention comprises:
a method, system or application capable of storing user, customer, giver, product, sales, order, supplier, vendor, and any other pertinent data associated with the same; p1 a method, system or application capable of creating an order;
a method, system, or application capable of generating an invoice or an amount due;
a method, system, or application capable of converting a donation request into stored value;
a method, system, or application of storing value converted from the acceptance of a donation request presented by a user;
a method, system, or application with processing functionality that allows stored value to complete the payment for the order, payment for an invoice or other presentment of debt from a purchase made with a giver;
a method, system, or application utilizing a payment gateway that allows the transferring of the stored value from the buyer to the seller upon completion of the order;
a method, system, or application in which a virtual wallet is used to store value;
a method, system, or application which utilizes a marketplace to create, redeem, and sell stored value;
a method, system, or application which utilizes an advertising platform that displays, markets, and sells stored value to consumers;
a method, system, or application that utilizes a gift, loyalty, or rewards program that will allow stored value to be purchased, earned, redeemed, sold, transferred, or donated;

3. The application of claim 2 further allows the present invention to be implemented and operated within an application programming interface.

4. The application of claim 2 further allows the present invention to be implemented and operated within a shopping cart plugin or extension.

5. The application of claim 2 further allows the present invention to be implemented or operated within an electronic payment processing terminal, pin-pad device, card reader, payment gateway, tokenization service, EMV device, payment facilitator platform, or P2P payment services including but not limited to trade or bartering software or

6. The application of claim 2 further allows the present invention to be implemented or operated within a point of sale application, interface, or other Software-as-a-Service that provides point of sale, accounting, invoicing, checkout, gift, loyalty, or rewards functionality.

7. The application of claim 2 further allows the present invention to be implemented and operated within a website or electronic commerce (E-commerce), or block-chain environment.

8. The application of claim 2 further allows the present invention to be implemented or operated within a mobile, cellular, or smart television technology application.

9. The application of claim 2 further allows the present invention to be implemented within or operated by gaming or virtual reality software or applications.

10. The application of claim 2 further allows the present invention to create and market a branded stored value donation during the use of a trade or barter payment gateway, platform, service, software or application relating to the same.

12. The application of claim 2 further allows for marketing a branded stored value donation using electronic and non-electronic forms of advertising media.
